(19) United States
(12) Patent Application Publication
(10) Pub. No.: US 2020/0020501 A1
(43) Pub. Date: Jan. 16, 2020

(54) Chip Scale Encapsulated Vacuum Field Emission Device Integrated Circuit and Method of Fabrication Therefor

(71) Applicant: The Charles Stark Draper Laboratory, Inc., Cambridge, MA (US)

(72) Inventors: Jonathan J. Bernstein, Medfield, MA (US); Peter Q. Miraglia, Hanover, MA (US); Daniel Freeman, Cambridge, MA (US); Steven J. Byrnes, Watertown, MA (US)

(21) Appl. No.: 16/034,770

(22) Filed: Jul. 13, 2018

(51) Int. Cl. H01J 3/02; H01J 21/10; H01J 9/02

(52) U.S. Cl. CPC H01J 3/021; H01J 9/025; H01J 21/105

(57) ABSTRACT

A chip scale encapsulated vacuum field emission device integrated circuit and method of fabrication therefor are disclosed. The vacuum field emission device is a monolithically fabricated triode vacuum field emission device, also known as a VACFET device. The VACFET device includes a substrate, a VACFET formed laterally on the substrate, and a containment shell that seals around a periphery of the VACFET and against the substrate. Preferably, the VACFET of the VACFET device includes an anode and a cathode formed on the substrate, a bottom gate and a top gate. The bottom gate is located between the anode and the cathode and the substrate, and the top gate is located above the anode and the cathode with respect to the substrate.

### BACKGROUND OF THE INVENTION

Vacuum tube-based field emission devices outperform semiconductor transistors in some harsh environments. Examples include high temperature and high radiation environments, such as in the nuclear power industry, in particle physics research, and in outer space. In contrast, the semiconductor transistors typically fail or degrade in the same environments.

The vacuum tube-based field emission devices also outperform semiconductor-based transistors in high frequency and high power applications. Exemplary applications include power generation and distribution, medical imaging, and military applications. In these applications, the semiconductor transistors are limited by electrical breakdown at high voltage and the low velocity of electron transport.

However, the vacuum tube-based field emission devices have many drawbacks. These devices are typically large, expensive to build, require significant input power and warm-up time before they are fully operational, and are fragile. As a result, usage of these devices in modern electronics is typically limited.

In contrast, the semiconductor transistors have many advantages over the vacuum tube-based field emission devices. Examples of semiconductor-based transistors include bipolar transistors and complementary metal oxide semiconductor (CMOS) field effect transistors (FETs), also known as MOSFETs. These transistors are much less expensive to produce, require lower input voltages and consume less power during operation, are more reliable, and can be monolithically fabricated to include possibly millions of individual transistors in an integrated circuit chip. As a result, the semiconductor transistors such as MOSFETs are favored over the vacuum tube-based field emission devices in the vast majority of applications.

Recently, monolithically fabricated vacuum field emission devices have been proposed. These devices combine the high radiation tolerance and temperature limits of vacuum tube-based field emission devices with the monolithic fabrication of semiconductor-based transistors such as MOSFETs. Examples of these vacuum field emission devices include two and three-terminal diode and triode vacuum field emission devices, respectively. The triode vacuum field emission devices are also known as VACFET devices.

Each VACFET device is generally constructed as follows. A cathode, an anode, and one or more gates are fabricated on the substrate. These elements might be fabricated using photolithography to pattern successive layers on the substrate. Another approach relies on deep reactive ion etching (DRIE) to fabricate the cathode, anode and gates.

In general, there are two ways of orienting the VACFETs with respect to the substrates on which they are fabricated. One way is to orient the VACFETs vertically with respect to the substrates. Here, each VACFET is oriented such that an electron beam path between the cathode and anode of the VACFET is substantially perpendicular to a plane of a top surface of the substrate. In these vertically formed VACFETs, the cathode is typically formed on the substrate, and the anode is formed so that the anode is over the cathode. Often, the cathode/anode are formed in a Spindt cathode configuration. Another way of orienting the VACFETs is laterally with respect to the substrates. In these laterally formed VACFETs, each VACFET is oriented such that the electron beam path between the cathode and the anode is substantially parallel to the plane of the top surface of the substrate. The gate(s) of the VACFETs are typically located on either side of the electron beam path.

There are also two basic approaches to applying the vacuum to VACFETs. In one approach, the VACFET devices are housed within a separate enclosure like a bell jar or hermetic package, and then the enclosure is evacuated. This is known as a package-level vacuum seal. In another approach, the VACFETs are in situ vacuum encapsulated/sealed, sometimes referred to as a chip-level vacuum seal. Here, a conductive metallic layer might be applied to the VACFET while the VACFET is under vacuum to create a vacuum seal for the VACFET.

The following references describe some of these existing VACFET devices: C. M. Park, M. S. Lim, and M. K. Han, “A Novel In Situ Vacuum Encapsulated Lateral Field Emitter Triode,” IEEE Electron Device Letters, Vol, 18, NO. 11, November 1997; V. Milanovi, L. Doherty, D. Teasdale, C. Zhang, S. Parsa, and K. S. J. Pister, “Application of Micromachining Technology to Lateral Field Emission Devices,” Solid-State Sensor and Actuator Workshop, Hilton Head, June 2000; and K. Subramanian, W. P. Kang, J. L. Davidson, N. Ghosh, and K. F. Galloway, “A review of recent results on diamond vacuum lateral field emission device operation in radiation environments,” Electrical and Computer Engineering Department, Vanderbilt University, Nashville, Tenn. 37235, USA, Microelectronic Engineering 88 (2011) 2924-2929.

### SUMMARY OF THE INVENTION

The existing VACFET devices have limitations. The devices that use package-scale vacuum sealing can be costly and can have a large form factor and limited interconnect capability. The devices that use chip-level vacuum sealing may use a conductive metallic layer applied to the entirety of the device. Such devices require fabrication of additional insulating layers and possibly additional metal layers to provide separate metal contacts to the cathode/anode/gate(s), which increases complexity and cost. Another limitation to some designs is the number of gates. A single gate not only places an upper ceiling on the transconductance of the device, but unwanted gate current is also induced. Moreover, some VACFET designs include charge-trapping dielectric materials in the vicinity of the electron beam path, which limits the radiation hardness of the devices.

The VACFET device proposed here includes a substrate, a laterally formed VACFET on the substrate, and potentially a device-level vacuum seal.

The proposed VACFET device overcomes the vacuum sealing limitations of some existing VACFET devices. In one example, the device-level vacuum sealing of the proposed VACFET device can achieve a better vacuum in a smaller form factor than the package-sealed VACFET devices.

In a preferred embodiment, the proposed VACFET device has two gates. Such a device improves transconductance of the device and decreases overall current induced at the gates as compared to existing VACFET devices with only one gate.

The proposed VACFET device also overcomes the radiation hardening limitations of the existing VACFET devices. In the proposed device, charge trapping dielectrics are eliminated from the vicinity of the electron beam path of the VACFET of the device.

In general, according to one aspect, the invention features a monolithically fabricated vacuum field effect transistor (VACFET) device. The VACFET device includes a substrate, a VACFET formed laterally on the substrate, and a containment shell that seals around a periphery of the VACFET and against the substrate. The VACFET includes an anode and a cathode formed on the substrate, and a bottom gate located between the anode and the cathode and the substrate. Typically, the cathode overlaps the bottom gate.

Preferably, the VACFET includes a top gate located above the anode and the cathode with respect to the substrate, and the top gate is housed within the containment shell. Typically, the cathode also overlaps the top gate, and the anode and the cathode are cantilevered above the substrate and over the bottom gate.

The VACFET device also includes a metal plug for closing an opening in the shell and creating a vacuum seal. Additionally, the metal plug functions as a metal contact that provides an electrical connection to the VACFET.

In general, according to another aspect, the invention features a method for monolithic fabrication of a VACFET device. The method includes forming a VACFET laterally on a substrate, and fabricating a containment shell that seals around a periphery of the VACFET and against the substrate.

In one example, the containment shell is fabricated by depositing a shell layer and then patterning the shell layer to form the containment shell, removing a sacrificial material, and then sealing the containment shell with a metal plug.

Typically, forming the VACFET laterally on the substrate includes fabricating a bottom gate, and then fabricating an anode and cathode cantilevered over the bottom gate. Preferably, forming the VACFET laterally on the substrate additionally includes fabricating a top gate over the cathode and the anode, with respect to the substrate.

In another example, fabricating the top gate over the cathode and the anode, with respect to the substrate includes fabricating an upper oxide sacrificial layer over the cathode and the anode, with respect to the substrate, fabricating the top gate on the upper oxide sacrificial layer, and removing the upper oxide sacrificial layer. Typically, the cathode is fabricated to overlap the top gate and the bottom gate.

In general, according to another aspect, the invention features a monolithically fabricated VACFET. The VACFET includes a substrate, a bottom gate formed on the substrate, and a cathode and an anode located above the bottom gate. The VACFET also includes a top gate, wherein the top gate and the bottom gate are located at different heights relative to the substrate. In one implementation, the top gate and the bottom gate are offset symmetrically about an electron beam path between the cathode and the anode. In another implementation, the anode and the cathode are cantilevered above the substrate.

In general, according to another aspect, the invention features a method for monolithic fabrication of a VACFET. The method includes fabricating a bottom gate upon a substrate, fabricating a cathode and an anode over the bottom gate, with respect to the substrate, and fabricating a top gate over the cathode and the anode, with respect to the substrate. Additionally, the method includes fabricating a lower oxide sacrificial layer over the bottom gate prior to fabricating the cathode and the anode. In one example, the anode and the cathode are cantilevered above the substrate.

The method also includes fabricating an upper oxide sacrificial layer over the cathode and the anode prior to fabricating the top gate. Additionally and/or alternatively, the method fabricates the cathode to overlap the top gate and the bottom gate.

In general, according to yet another aspect, the invention features a monolithically fabricated vacuum field effect transistor (VACFET) device. The VACFET device includes a substrate, a VACFET formed on the substrate, and at least one magnetic flux concentrating structure for concentrating magnetic flux in a cathode-anode gap of the VACFET.

In general, according to still another aspect, the invention features a VACFET system. The VACFET system includes a magnetic field source that generates a magnetic field, and an integrated circuit chip with VACFET devices in the magnetic field.

In general, according to yet an additional aspect, the invention features a method for assembling an integrated circuit VACFET with magnetic guidance. The method includes generating a magnetic field from a magnetic field source, and placing an integrated circuit chip with VACFET devices in the magnetic field.

It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale, emphasis has instead been placed upon illustrating the principles of the invention. Of the drawings:

FIG. 1A is a schematic partial top view of an embodiment of a VACFET device, constructed in accordance with principles of the present invention;

FIG. 1B is a schematic partial top view of another VACFET device, according to a preferred embodiment;

FIG. 2 is a schematic cross-section of the VACFET device in FIG. 1B, where the figure shows various layers of the VACFET device and components of a VACFET formed within the layers;

FIG. 3A and FIG. 3B are flow charts showing methods of fabrication for exemplary VACFET devices having a single gate and two gates, respectively;

FIGS. 4A through 4D are cross-sectional views of a VACFET device at different stages of fabrication, in accordance with initial fabrication steps that are common to the methods of FIGS. 3A and 3B;

FIGS. 5A and 5B are cross-sectional views of a single gate VACFET device at later stages of fabrication, in accordance with the method of FIG. 3A;

FIGS. 6A through 6E are cross-sectional views of the two-gate VACFET device of FIG. 1B at later stages of fabrication, in accordance with the method of FIG. 3B;

FIG. 7A is a schematic diagram of another embodiment of a VACFET device including a flux-concentrating film structure,

FIG. 7B is a schematic perspective view of an exemplary VACFET system that includes VACFET devices in an integrated circuit chip, where the chip is placed within a magnetic field, and the VACFET devices are constructed in accordance with FIG. 7A; and

FIGS. 8A-8D are schematic top views showing simulated trajectories of electron beam paths at a micrometer scale within different VACFET devices, where: FIG. 8A shows the trajectory of electrons for a single gate VACFET device that has not been placed in a magnetic field; FIG. 8B shows the trajectory of electrons when the VACFET device of FIG. 8A is placed in a magnetic field to “steer” electrons away from the gate; FIG. 8C shows the trajectory of electrons for a two-gate VACFET device that has not been placed in a magnetic field; and FIG. 8D shows the trajectory of electrons when the VACFET device of FIG. 8C is placed in a magnetic field to steer electrons away from the gates.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Generally, the term VACFET refers to a triode field emission device including an anode, a cathode, and one or more gates.

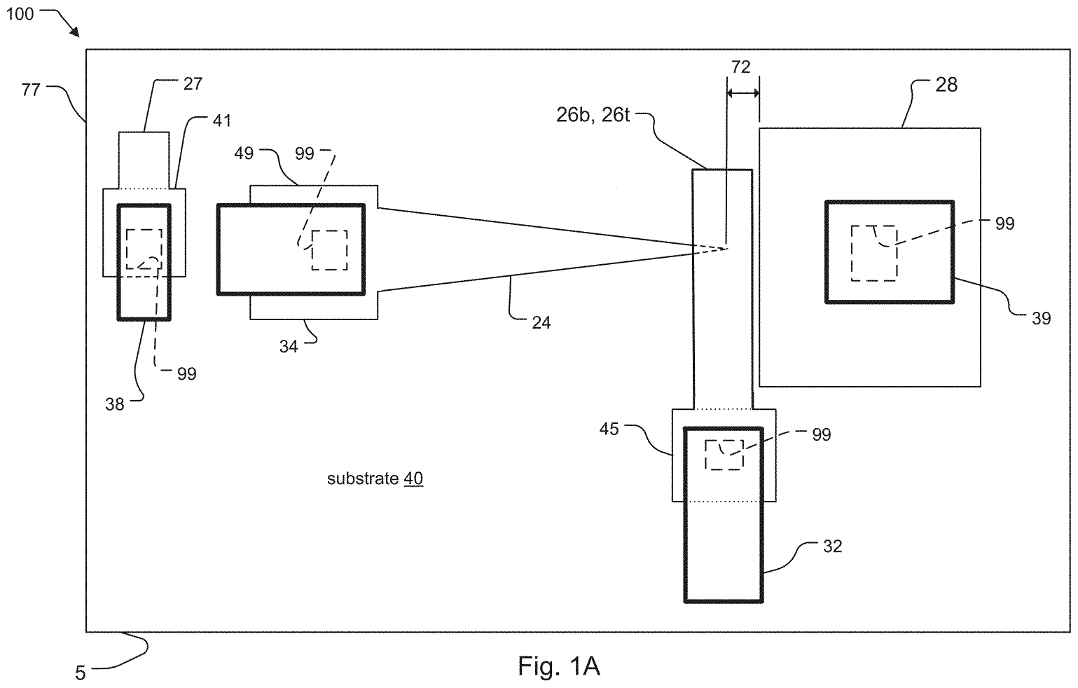

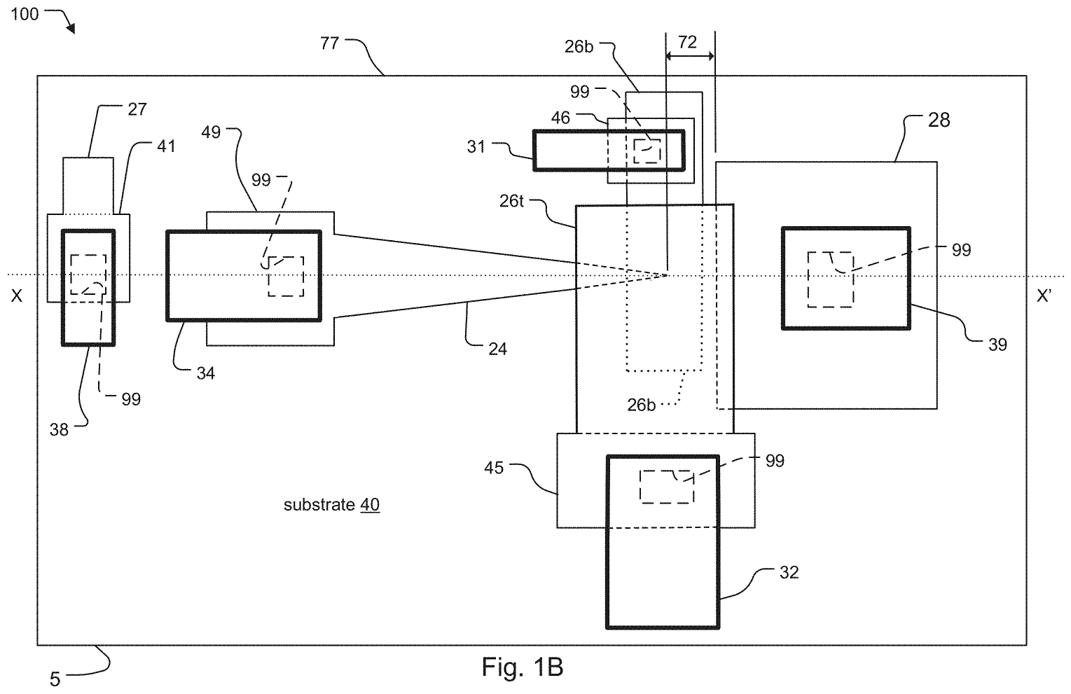

FIG. 1A is a schematic partial top view of an embodiment of a VACFET device 100.

In the illustrated example, the VACFET device 100 includes a substrate 40, and the VACFET laterally oriented or formed on the substrate 40. Though not shown in FIG. 1A due to the fact that the view is partial top view, the VACFET device 100 also includes a containment shell that seals around a periphery 77 of the VACFET and directly or indirectly against the substrate 40. A front surface 5 of the VACFET device 100 is also indicated.

The VACFET includes a cathode 24, an anode 28, and at least one gate 26. In a preferred embodiment, the VACFET includes a bottom gate 26b and a top gate 26t. Here, the bottom gate 26b is not shown, as the top gate 26t is “stacked” on top of the bottom gate 26b in this view.

A cathode-anode gap 72 is also shown between the cathode 24 and the anode 28. During operation of the VACFET, electrons travel in an electron beam path from the cathode 24 to the anode 28, across the cathode-anode gap 72.

The bottom gate 26b, the cathode/anode, and the top gate 26t are located at different heights with respect to the substrate 40. The cathode/anode are located above the bottom gate 26b, and the top gate 26t is located above the cathode/anode. These different heights allows the cathode to overlap the bottom gate 26b and top gate 26t in the direction of the electron beam path between the cathode 24 and anode 28. In the preferred embodiment, the amount of overlap is greater than 10% of the width of the bottom gate 26b and/or top gate 26t in the direction of the electron beam path.

In the illustrated example, the bottom and top gates 26b/26t are of substantially the same width in the direction of the electron beam path. The gates 26 are also coextensive across the substrate 40.

A metal substrate contact 38, a metal gate contact 32, a metal cathode contact 34, and a metal plug 39 are also shown. These metal contacts/plugs provide electrical connections to the VACFET anode 28, cathode 24 and gates 26b/26t, and the substrate 40. In more detail, the metal substrate contact 38 extends into a via 99 etched down to a substrate connector 27. Near the metal substrate contact 38, the substrate connector 27 widens to a pad 41. The pad 41 is shown under the metal substrate contact 38. When the via 99 is filled with metal, the contact 38 is electrically connected to the substrate connector 27 and thus the substrate 40.

The metal contact 32 provides an electrical connection to both the bottom and top gates 26b, 26t in this illustrated embodiment. In more detail, the metal gate contact 32 extends into a via 99 etched down to the bottom and the top gates 26b/26t. Near the metal gate contact 32, the bottom and top gates 26b/26t widen to a gate pad 45. The gate pad 45 is shown under the metal gate contact 32. When the via 99 of the contact 32 is filled with metal, the contact 32 is electrically connected to the bottom and top gates 26b/26t.

The metal cathode contact 34 provides an electrical connection to the cathode 24. In more detail, the metal cathode contact 34 extends into a via 99 etched down to the cathode 24. Near the metal cathode contact 34, the cathode 24 widens to a cathode pad 49. The cathode pad 49 is shown under the metal cathode contact 34. When the via 99 of the metal cathode contact 34 is filled with metal, the contact 34 is electrically connected to the cathode 24.

The metal plug 39 functions as a metal contact that provides an electrical connection to the anode 28. In more detail, the metal plug 39 extends into a via 99. When the via 99 of the metal plug 39 is filled with metal, the metal plug 39 provides an electrical connection to the anode 28.

FIG. 1B is a schematic partial top view of another embodiment of the VACFET device 100. The VACFET device in FIG. 1B is similar in construction and operates in a substantially similar manner as the VACFET device in FIG. 1A.

The VACFET device in FIG. 1B is different than the device of FIG. 1A in some aspects. For example, the bottom gate 26b is smaller in width than the top gate 26t, in the direction of the electron beam path. Also, the bottom gate 26b and the top gate 26t are not coextensive. In addition, there is an additional metal contact 31 having a via 99. This metal contact 31, in conjunction with the metal contact 32, provide separate electrical connections to the bottom and top gates 26b,26t in FIG. 1B. A dual gate VACFET may be useful as an RF mixer, modulator, or demodulator analogous to the use of dual-gate MOSFETs.

The metal contacts 31, 32 provide separate electrical connections to the bottom and top gates 26b,26t as follows. The top gate 26t and the bottom gate 26b widen to separate gate pads 45 and 46, respectively. The via 99 of the metal contact 31 is etched down to the bottom gate 26b, and the via 99 of the metal contact 32 is etched down to the top gate 26t. The gate pads 45,46 of top and bottom gates 26t,26b are shown under the metal contacts 32 and 31, respectively. When metal is added to the via 99 of the metal contact 32, the contact 32 is electrically connected to the top gate 26t. In a similar vein, when metal is added to the via 99 of the metal contact 31, the contact 31 is electrically connected to the bottom gate 26b.

A line indicated by reference x-x′ defines a cross-sectional “cutting plane” through the VACFET device 100, in the direction of the electron beam path of the VACFET. This cross-sectional plane runs down from the top of the VACFET device 100 towards the substrate 40, is perpendicular to the plane of the top surface of the substrate 40, and runs across the cathode/anode, the gates 26, the metal contacts 34, 38 and the metal plug 39.

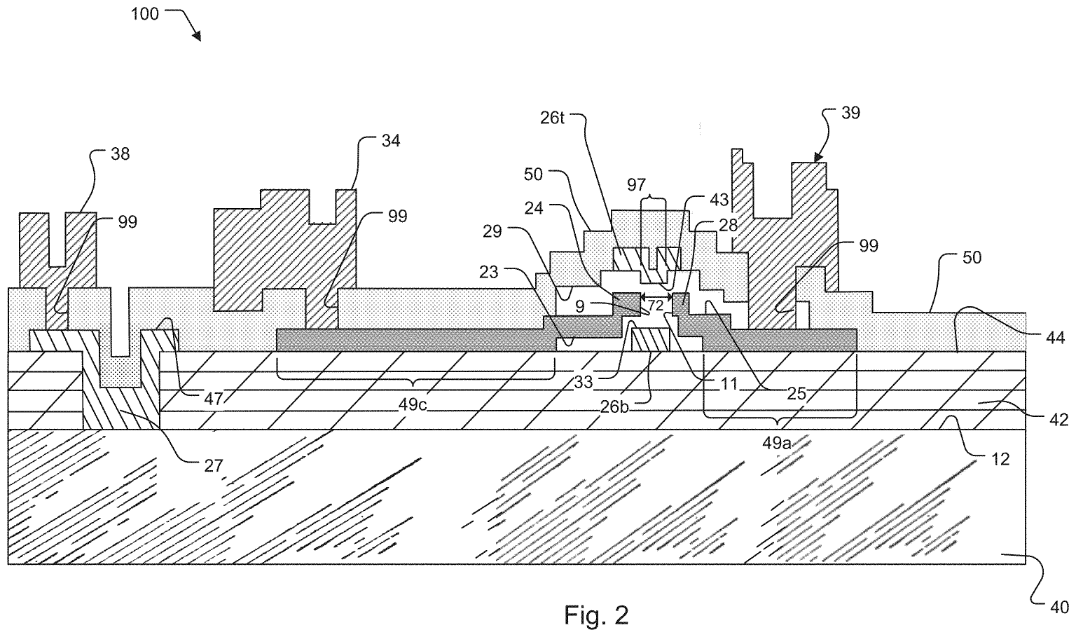

FIG. 2 is a cross-section of the completed VACFET device 100 in FIG. 1B. Here, the cross-section of the VACFET device 100 is along the cross-sectional “cutting plane” defined by line x-x′ in FIGS. 1B and 1s viewed from the front surface 5 of the VACFET device 100.

The view provided by this figure shows aspects of the VACFET device 100 that could not be shown in FIG. 1B. In examples, the view shows various layers of the VACFET device 100 formed on the substrate 40 and components of the VACFET formed on the substrate 40 that were not visible in FIG. 1B. Of particular interest is a containment shell 50 that seals around the periphery of the VACFET and against the substrate.

Fabrication of each layer in the VACFET device 100 is typically carried out as follows. Material of each layer is applied to the substrate 40, followed by patterning of the layer or patterning the layer during deposition such as with a shadow mask or patterning with a lift-off process. Each layer is typically fabricated on top of one or more previously fabricated layers. Additionally, fabrication of a layer might also include removing components or structures formed from previously fabricated layers.

Applying the material of each layer can be accomplished by various techniques. These techniques including deposition, in-situ growth, diffusion, or ion implantation followed by an annealing process, in examples. Methods for deposition include plasma-enhanced chemical vapor deposition (PECVD) or low-pressure chemical vapor deposition (LPCVD), in examples.

The VACFET device 100 includes the substrate 40. The substrate 40 has a top surface 12. The substrate 40 is preferably a silicon wafer. The VACFET is then formed on the substrate 40.

A dielectric isolation layer 42 is formed on and is in contact with the substrate 40. The layer 42 has an opening that exposes the substrate 40. In one example, the dielectric isolation layer 42 is made of silicon nitride having a low residual stress property.

The substrate interconnect 27 and the bottom gate 26b are located on top of the dielectric isolation layer 42. The substrate interconnect 27 is formed such that the material of the substrate interconnect 27 partially fills the opening in the dielectric isolation layer 42 and comes into contact with the substrate 40. A top surface 47 of the substrate interconnect 27 is also shown.

The cathode 24 and the anode 28 are also on top of the dielectric isolation layer 42. A base portion 49c and 49a of the cathode 24 and anode 28, respectively, are each exposed to the dielectric isolation layer 42. The base portions 49c/49a provide structural support for cantilevered portions of the cathode 24/anode 28. These cantilevered portions of the cathode 24/anode 28 extend above the bottom gate 26b with respect to the substrate 40.

The cathode-anode gap 72 separates the cathode 24 from the anode 28. Nearest to the cathode-anode gap 72, the cathode 24 and the anode 28 respectively end in proximal faces 9, 11. The proximal faces 9/11 are surfaces of the cathode 24/anode 28 that are nearest to the electron beam path between the cathode 24 and the anode 28. The electron beam path between the cathode 24 and anode 28 is substantially parallel to a plane of the top surface 12 of the substrate 40.

A lower void separates the cantilevered portions of the cathode 24 and the anode 28 from the bottom gate 26b. In the illustrated example, the lower void is left after removing a lower oxide sacrificial layer. Specifically, the lower void is defined between a top surface 44 of the dielectric isolation layer 42 and an inside wall 23 of the cathode/anode. The bottom gate 26b is also located within the lower void.

The top gate 26t is located at a height above the cantilevered portions of the cathode and the anode with respect to the substrate 40. The top gate 26t and the bottom gate 26b are located at different heights relative to the substrate 40.

Proximal faces 33 and 43 of the bottom gate 26b and the top gate 26t, respectively, are also shown. These proximal faces 33/43 are surfaces of the gates 26b/26t that face the cathode/anode. The faces 33/43 are substantially parallel to the electron beam path between the cathode 24 and anode 28.

An inter-gate volumetric region is defined between the proximal face 33 of the bottom gate 26b, projected upward towards the proximal face 43 of the top gate 26t. The cathode 24 overlaps the bottom gate 26b and the top gate 26t. That is, the proximal face 9 of the cathode 24 extends substantially into the inter-gate volumetric region, in a direction from the cathode 24 to the anode 28 along the direction of the electron beam path. In one example, “substantially” is when the proximal face 9 of the cathode 24 extends about 10% or more into the inter-gate volumetric region, with respect to the total width of the inter-gate volumetric region in that direction.

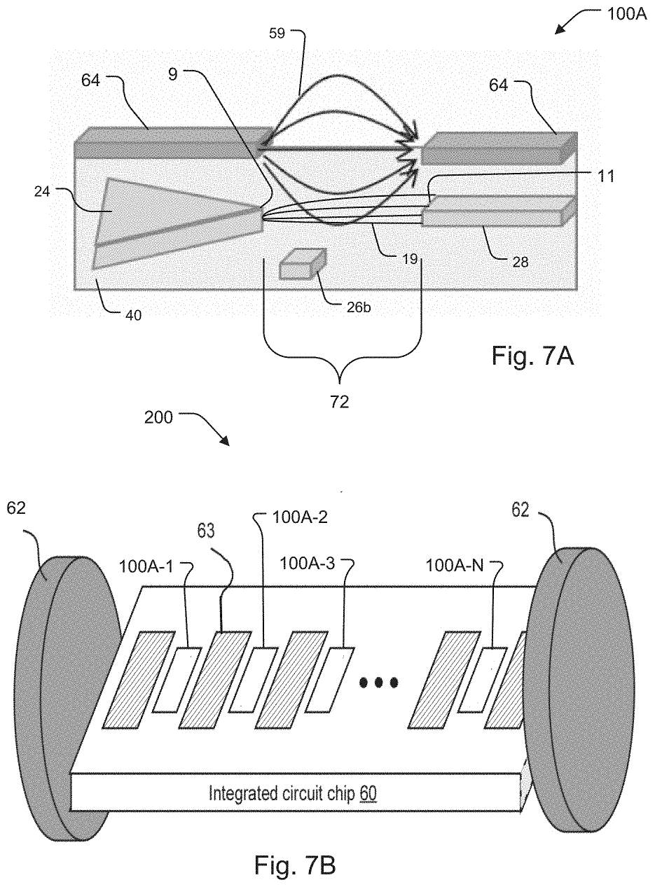

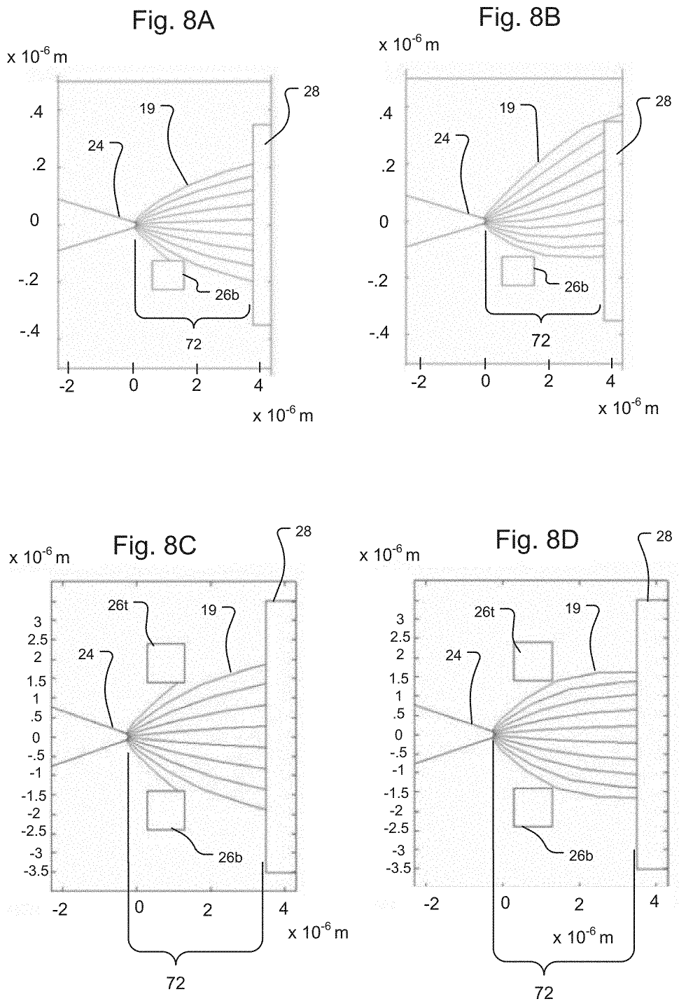

In general, it is advantageous but not necessary for the cathode 24 to overlap the gates 26. The primary advantage for the cathode 24 to overlap the gates 26 is to decrease the number of electrons that come into contact with the gates 26 during operation of the VACFET. Such a decrease in the number of electrons coming into contact with the gates 26 reduces unwanted current and noise at the gates 26. More information concerning the ability of the VACFET device 100 to reduce unwanted current and noise at the gates 26 is provided in the descriptions accompanying FIG. 7B and FIG. 8A-8D, included hereinbelow. Though the cathode 24 and the anode 28 are structurally supported by their base portions 49c and 49a, there is no structural support for the cathode/anode near the cathode-anode gap 72, or in the inter-gate volumetric region. As a result, the cathode 24 and the anode 28 are said to be cantilevered above the substrate 40 and over the bottom gate 26b.

An upper void also separates the cathode 24 and the anode 28 from the top gate 26t. In the illustrated example, the upper void is left after removing an upper oxide sacrificial layer. Here, the upper void is defined between an upper side 25 of the cathode/anode and an inside wall 29 of the containment shell 50.

The proximal face 43 of the top gate 26t is also located on a portion of the top gate 26t that faces and extends partially into the upper void, downwards towards the cathode-anode gap 72.

The containment shell 50 seals indirectly against the substrate 40 in the illustrated embodiment. Specifically, the shell 50 is shown sealing directly against the dielectric isolation layer 42, while another part of the shell 50 is deposited on the cathode/anode, which in turn are on the dielectric isolation layer 42. Yet another portion of the shell 50 is deposited upon the top surface 47 of the substrate interconnect 27. In examples, the shell 50 is made from non-conducting material such as silicon carbide or low stress silicon nitride.

The metal contacts 34, 38 and the metal plug 39 are also shown. The metal plug 39 closes an opening in the shell 50 and creates a vacuum seal. The metal plug 39 also functions as a metal contact (here, for the anode 28) to provide an electrical connection to the VACFET. Similarly, the metal cathode contact 34 closes and extends through another opening in the shell 50 and provides an electrical connection to the cathode 24. The metal substrate contact 38 closes and extends through another opening in the shell 50 and provides an electrical connection to the substrate interconnect 27.

The VACFET device 100 is radiation hardened. There are no charge-trapping dielectric materials in the vicinity of the electron beam path. Rather, lower and upper voids are located between the proximate faces 33,43 of the bottom and top gates 26b, 26t and the cathode/anode.

Table 1 describes preferred and alternate materials for various layers from which the VACFET device 100 is formed, and for various components formed from the layers.

TABLE 1
Preferred and Alternate Materials for Various Layers and Components

| Layer Purpose | First choice/preferred | Alternatives |
|---|---|---|
| substrate wafer 40 | Si | SiO₂, AlN, SiC, glass (e.g. |
| | | Hoya SD2), GaN, GaAs |
| dielectric isolation layer 42 | Low residual stress silicon | SiC, Al₂O₃, AlN. If substrate |
| | nitride | is insulating, this layer is |
| | | optional |
| bottom and top gate layers | Polysilicon (with n or p type | SiC, diamond, various metals |
| 26b, 26t | doping) | and alloys such as Al, Ta, Ti, |
| | | W, TiW, Nb, and Mo |
| upper and lower sacrificial | SiO₂ | Polysilicon, Ti, W, TiW alloy |
| layers | | |
| cathode 24 and anode 28 | n-type nanodiamond | Various metals (Pt, Ru, W, |
| | | Mo, Ir, Ta), other forms of |
| | | carbon (graphene, |
| | | microcrystalline diamond) |
| shell 50 | SiC, via plasma-enhanced | Low stress SiN |
| | chemical vapor deposition | |
| | (PECVD) or low-pressure | |
| | chemical vapor deposition | |
| | (LPCVD) | |
| metal contacts 32/34/38 and | Titanium (Ti) | Cr, W, Ta, Zr, V, Mo, Al, |
| metal sealing plug 39 | | TiW, and TiZrV |
| bondpad metal 52 | Cr/Pt/Au stack | Al, Cu |

In Table 1, if alternate materials for the sacrificial layers are selected (e.g. polysilicon, Ti, W, and TiW alloy), then the materials selected for the gate(s) 26 and the cathode 24/anode 28 might require replacement with materials that are not attacked during sacrificial layer etch. For example, if polysilicon is chosen as the material for the sacrificial layers, XeF₂ is typically used to etch polysilicon. As a result, the preferred polysilicon material for the bottom and top gates 26b, 26t must be replaced with a material such as SiC or aluminum that is not attacked by XeF₂.

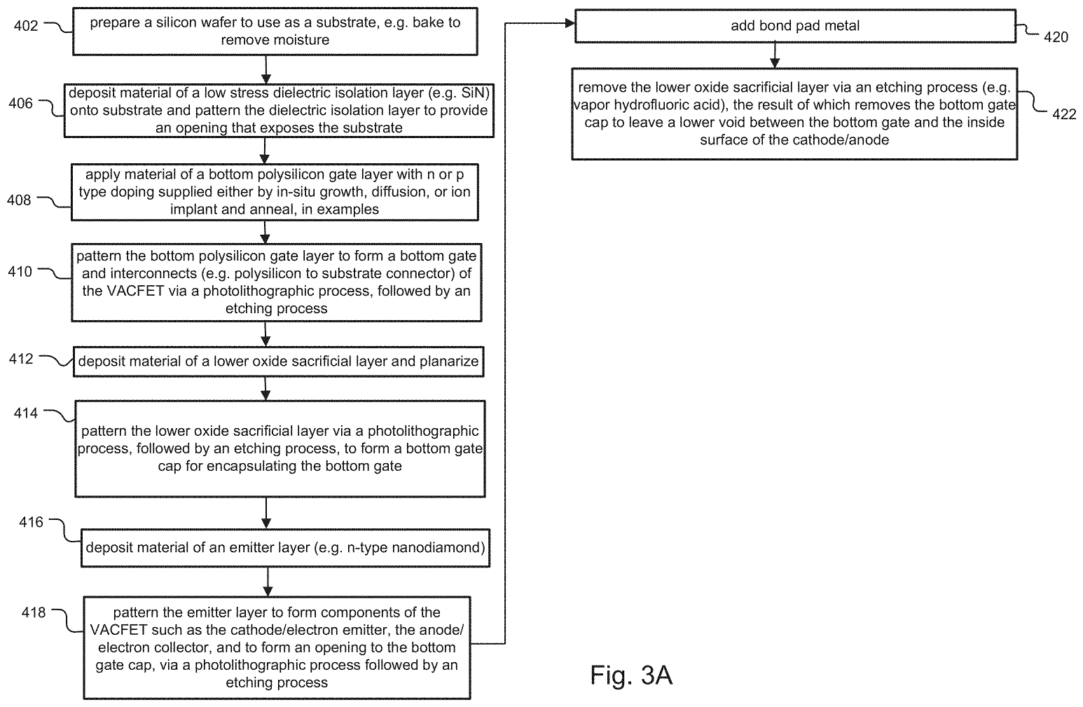

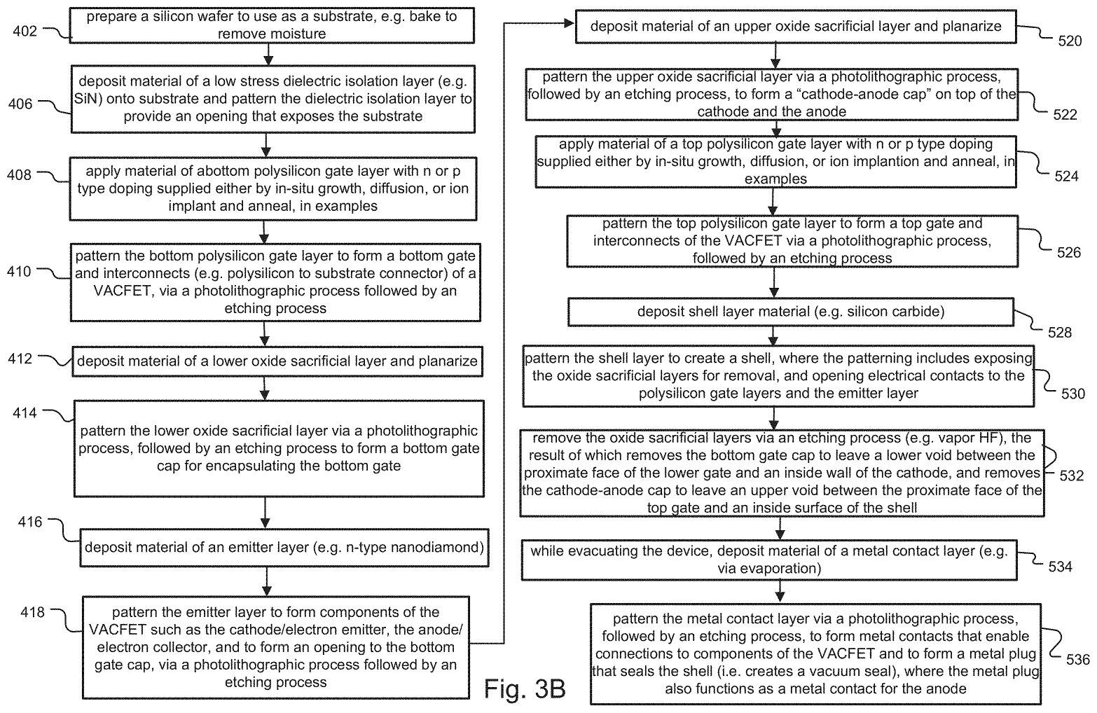

FIG. 3A and FIG. 3B are flow charts showing methods of fabrication for exemplary VACFET devices 100 having a single gate and two gates, respectively. The methods of FIGS. 3A and 3B share an initial set of common fabrication steps, which are steps 402 through 418. Each method describes how its respective VACFET device 100 is fabricated.

In FIG. 3A and FIG. 3B, each of the layers except the substrate 40 might also be planarized after applying the material of each layer. Typically, one or more layers are planarized via a chemical-mechanical planarization process (CMP). Planarization of layers enables optical lithography of deep sub-micron features and very large scale integration (VLSI) of VACFET devices 100. The initial substrate 40 wafer does not require CMP, since typically all commercial wafers are already polished flat, at least on one side and perhaps on both.

FIG. 3A begins at step 402.

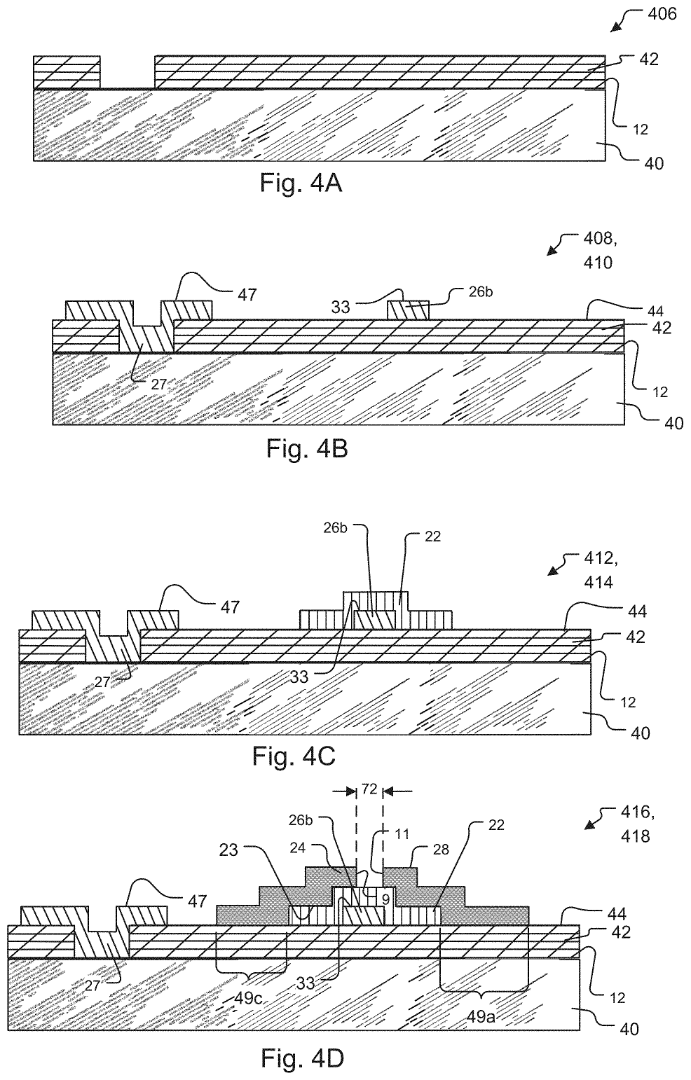

In step 402, a silicon wafer is prepared for use as the substrate 40, such as by chemical cleaning and baking the substrate 40 to remove any residual moisture. A low stress dielectric isolation layer 42 is then fabricated in step 406. In one example, the dielectric layer 42 is made of silicon nitride having a low residual stress property. This is shown in FIG. 4A.

To fabricate the dielectric isolation layer 42, in one example, a thin film of silicon nitride material is first applied by depositing the material onto the substrate 40. The material is then patterned to provide an opening that exposes a portion of the substrate 40.

In steps 408 and 410, a bottom polysilicon gate layer is fabricated. To fabricate the bottom polysilicon gate layer, in one example, a layer of polysilicon material with n or p type doping is first applied in step 408. The doping of the layer is supplied either during in-situ growth, or by diffusion or ion implant and anneal after film deposition, in examples.

Then, in step 410, the bottom polysilicon gate layer is patterned. The layer is patterned to form the bottom gate 26b and interconnects (e.g. polysilicon-based substrate connector 27), via a photolithographic process followed by an etching process. This is shown in FIG. 4B.

In another implementation, the bottom polysilicon gate layer is first fabricated using a damascene process and then planarized using CMP. This damascene process embeds the bottom polysilicon gate layer down into the dielectric isolation layer 42, and forms the substrate interconnect 27 and the bottom gate 26b in the embedded bottom polysilicon gate layer.

The damascene process for fabricating the bottom polysilicon gate layer typically has the following steps. First, after creating the opening in the dielectric isolation layer 42 for the substrate interconnect 27, shallow trenches are additionally etched into the dielectric isolation layer 42. Then, a thick layer of n or p type doped polysilicon material is deposited. The polysilicon material fills the opening to the substrate 40 and the trenches in the dielectric isolation layer 42. The portion of the polysilicon material that fills the opening to the substrate 40 forms the substrate interconnect 27, while the portion of the material that fills the trenches forms the bottom gate 26b.

The bottom polysilicon gate layer thus fabricated is then planarized via CMP. The planarization stops at the top surface 44 of the dielectric isolation layer 42. This provides a flat, smooth surface. After planarization, the top surface 47 of the substrate interconnect 27 and the proximal face 33 of the bottom gate 26b are coplanar with the top surface 44 of the dielectric isolation layer 42.

A lower oxide sacrificial layer is fabricated in steps 412 and 414. According to step 412, the lower oxide sacrificial layer is applied by depositing a layer of silicon dioxide material and then planarizing the material via CMP. The layer is then patterned via a photolithographic process, followed by an etching process, to form a bottom gate cap for encapsulating the bottom gate 26b, in step 414.

FIG. 4C illustrates fabrication of the VACFET upon completion of steps 412 and 414. Specifically, FIG. 4C shows the bottom gate cap 22 formed from fabrication of the lower oxide sacrificial layer. The bottom gate cap 22 encapsulates the bottom gate 26b.

Returning to the method of FIG. 3A, an emitter layer is then fabricated in steps 416 and 418. The material of the layer is first applied to the VACFET device 100 in step 416. In one example, the emitter layer is applied by depositing an n-type nanodiamond material.

In general, planarization of the emitter layer via CMP would typically not be performed. This is because the preferred material of this layer, nanodiamond, is extremely hard and would thus be very difficult to polish via CMP.

In step 418, the emitter layer is patterned to form components of the VACFET such as the cathode/electron emitter 24 and the anode/electron collector 28, and to create an opening to the bottom gate cap, via a photolithographic process followed by an etching process. This is shown in FIG. 4D.

Then, in step 420, bond pad metal is added.

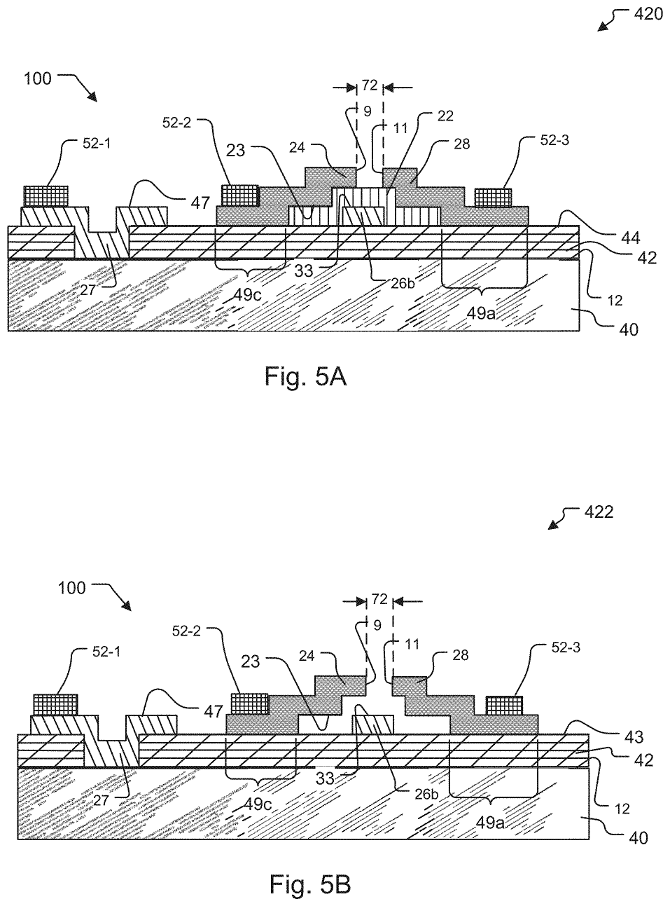

In FIG. 5A, metal contacts such as bond pads 52-1 through 52-3 are added to the substrate 40. In more detail, the pads 52-1 through 52-3 have been respectively bonded to the substrate interconnect 27, a top surface of the cathode 24 near its base portion 49c, and a top surface of the anode 28 near its base portion 49a.

Returning to the method of FIG. 3A, in step 422, the lower oxide sacrificial layer is removed. When the lower oxide sacrificial layer is made of a preferred material such as silicon dioxide, the layer is typically removed via a vapor hydrofluoric acid (HF) etching process. Upon completion of the etching, the bottom gate cap is removed to leave a lower void between the bottom gate 26b and the inside surface 23 of the cathode/anode 24/28.

FIG. 5B shows the single gate VACFET device 100 upon completion of its final stage of fabrication. In one embodiment, the containment shell 50 could also be fabricated upon the single-gate VACFET device 100. However, in the illustrated example, there is no containment shell 50. Rather, the device 100 (and thus the cathode-anode gap 72 and the lower void) are exposed to air at atmospheric pressure.

In more detail, the cathode-anode gap 72 is fabricated to be very small, on the order of a few micrometers down to tens of nanometers. At the lower end of this scale, electrons traveling in the electron beam path between the proximate face 9 of the cathode 24 and the proximate face 11 of the anode 28 typically do not collide with anything. This is because the mean free path of an electron, which is the average distance that an electron can travel between two successive collisions with another electron or gas molecule, is typically around 0.3 μm (micrometer) at atmospheric pressure. As a result, an evacuated containment shell 50 may not be required.

FIG. 3B describes a method for monolithic fabrication of the VACFET device 100 in FIG. 2. The method includes forming a VACFET laterally on a substrate, and fabricating a containment shell 50 that seals around the periphery of the VACFET and against the substrate 40. In one example, the containment shell is fabricated by depositing a shell layer and then patterning the shell layer to form the containment shell 50, and removing a sacrificial material and then sealing the containment shell 50 with the metal plug 39.

Steps 402 through 418 in FIG. 3B are the same as in FIG. 3A. Upon completion of step 410, the bottom gate 26b is fabricated. Upon completion of step 418, the anode 28 and the cathode 24 are fabricated. Additionally, upon completion of step 418, a bottom gate cap formed from a lower oxide sacrificial layer is also created. The bottom gate cap encapsulates the bottom gate 26b at this point in fabrication process. The method then transitions to step 520.

An upper oxide sacrificial layer is fabricated in steps 520 and 522. In step 520, material of the layer is applied. In one example, the layer is applied by depositing a thin film of silicon dioxide material, and the material is then planarized using CMP. In step 522, the upper oxide sacrificial layer is patterned via a photolithographic process, followed by an etching process, to form a “cathode-anode cap” on top of the cathode 24 and the anode 28.

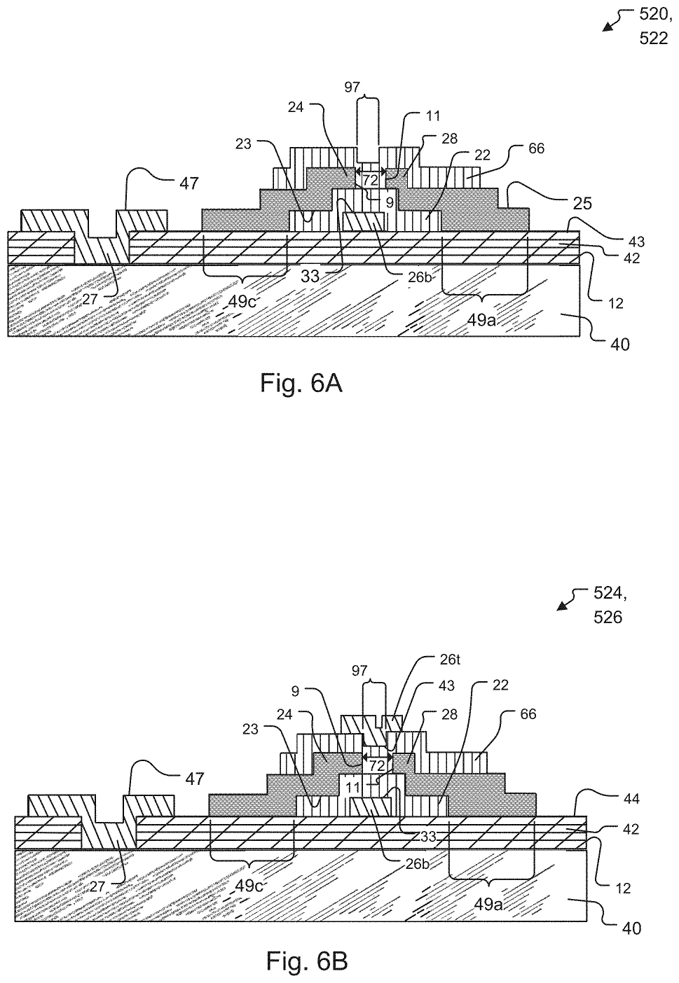

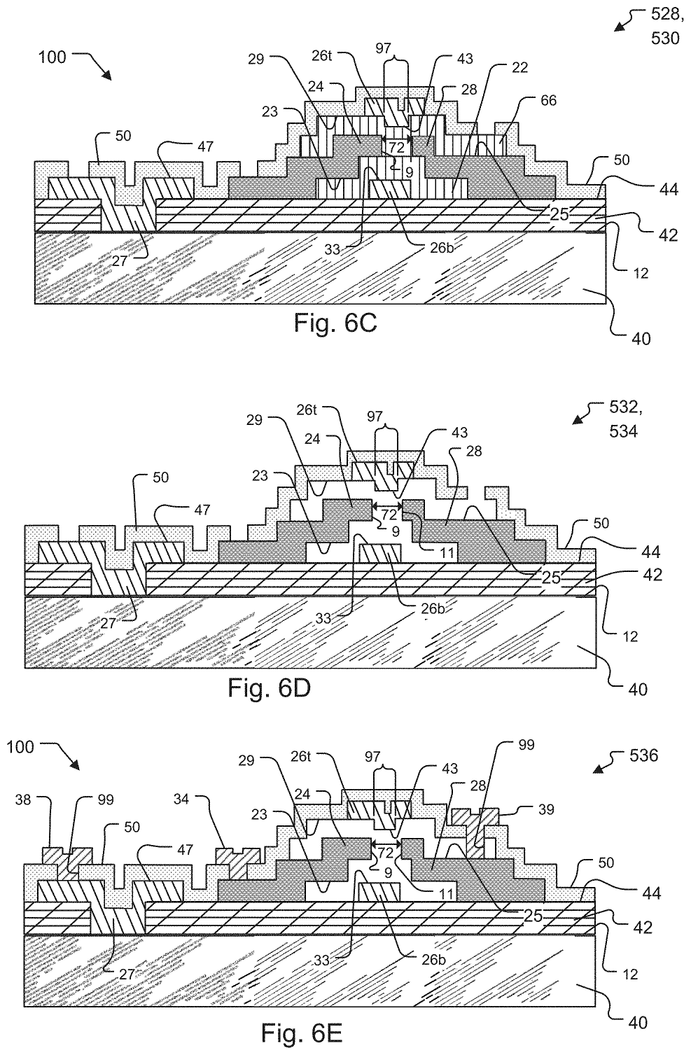

As shown in FIG. 6A, a notch 97 is formed in the cathode-anode cap 66 due to the conformal deposition of the sacrificial layer. Thus, the notch 97 is formed directly above the cathode-anode gap 72 with respect to the substrate 40.

Returning to the method of FIG. 3B, a top polysilicon gate layer is then fabricated in steps 524 and 526. In step 524, the layer is applied with n or p-type doping either by in-situ growth, diffusion, or ion implantation and anneal, in examples.

In another implementation, a second CMP step is executed after applying the material of the top polysilicon gate layer but prior to patterning of the layer. In preparation of this CMP step, a thick upper oxide sacrificial layer is first fabricated. The top polysilicon gate layer is then deposited, and the layer is planarized via CMP.

After the top polysilicon gate layer is planarized, the layer is patterned via a photolithographic process followed by an etching process to form the top gate 26t and interconnect structures.

According to step 526, the top polysilicon gate layer is patterned to form the top gate 26t and interconnects of the VACFET via a photolithographic process followed by an etching process.

As shown in FIG. 6B, the polysilicon material forming the top gate 26t fills the notch 97 located above the cathode-anode gap 72. The portion of the top gate 26t that fills this notch 97 ends in the proximal face 43 of the top gate 26t. Because the notch 97 is substantially symmetric with respect to the cathode-anode gap 72, the portion of the top gate 26t ending in the proximal face 43 is thus symmetric with respect to the cathode-anode gap 72.

As a result, forming the VACFET laterally on the substrate further comprises fabricating the top gate 26t over the cathode 24 and the anode 28, with respect to the substrate 40.

Returning to the method of FIG. 3B, a shell layer is fabricated in steps 528 and 530. In step 528, the layer is applied by depositing a thin film of material such as silicon carbide. According to step 530, the shell layer is patterned to create the containment shell 50. The patterning includes exposing the lower and upper oxide sacrificial layers for removal, and opening electrical contacts to the bottom and top polysilicon gate layers and the emitter layer. At this stage of fabrication, the only portion of the lower oxide sacrificial layer that remains is the bottom gate cap. In a similar vein, the only portion of the upper oxide sacrificial layer that remains is the cathode-anode cap 66. This is shown in FIG. 6C.

The lower and upper oxide sacrificial layers are removed via an etching process in step 532. When the material of these layers is silicon dioxide, the layers are typically etched via vapor Hydrofluoric acid (HF) to remove the layers. Specifically, etching removes the bottom gate cap and the cathode-anode cap. Removal of the bottom gate cap leaves the lower void between the proximate face 33 of the bottom gate 26b and the inside surface 23 of the cathode/anode. In a similar vein, removal of the cathode-anode cap leaves the upper void between the proximate face 43 of the top gate 26t and the inside surface 29 of the shell 50. This is shown in FIG. 6D.

As a result, in one implementation, fabricating the top gate 26t over the cathode 24 and the anode 28, with respect to the substrate 40 comprises fabricating the upper oxide sacrificial layer over the cathode and the anode, with respect to the substrate 40; fabricating the top gate 26t on the upper oxide sacrificial layer; and removing the upper oxide sacrificial layer.

A metal contact layer (metal layer) is fabricated in steps 534 and 536. In step 534, while evacuating the VACFET device 100, material of the metal layer is applied via deposition. In one example, the metal is deposited by evaporation. Then, in step 536, the metal layer is patterned via a photolithographic process, followed by an etching process. As a result, the metal contacts 34, 38 are formed that enable connections to components of the VACFET, and the metal plug 39 is also formed. The metal plug 39 seals the shell 50 (i.e. creates a vacuum seal), where the metal plug 39 also functions as a metal contact that provides an electrical connection to the anode 28. This is shown in FIG. 6E.

FIG. 6E shows a final fabrication stage of the VACFET device 100 shown in FIG. 2, in accordance with step 536 in FIG. 3B. Here, the metal contacts 34, 38 and the metal plug 39 for sealing the shell 50 are shown. In this way, the metal contacts 34, 38 and the metal plug 39 are fabricated/formed from a single metal layer.

The VACFET device 100 in FIG. 6E is substantially similar to the embodiment shown in FIG. 2. The major difference in FIG. 6E is that the metal contacts 34, 38 and the metal plug 39 are of substantially the same shape.

Integrated circuits of VACFET devices can also be fabricated using principles of the fabrication methods of FIGS. 3A and 3B described hereinabove. When creating the integrated circuits of VACFET devices, it can be appreciated that electronic components other than VACFETs/triodes can be fabricated. These additional electronic components include resistors, capacitors, and diodes, in examples.

The resistors could be formed using any of the conductive layers, such as the top and bottom polysilicon gate layers, or the emitter layer.

The capacitors could be fabricated as follows. Capacitors generally include two metal plates with a dielectric material located between the plates. The plates could be formed in any of the conductive layers. The dielectrics might be formed using the oxide sacrificial layer(s) or by using a vacuum dielectric, in examples. When using the oxide sacrificial layers to form the dielectrics, the portions of the oxide sacrificial layers forming the dielectrics would not be removed as part of the etching process/vapor HF to create the lower and upper voids, however.

The diodes, such as vacuum diodes, would typically be fabricated in substantially the same way as the triodes/VACFETs but with some modifications. One way of fabricating the diodes includes creating VACFETs, but then attaching the gate electrode(s) to a fixed voltage. Another way of fabricating the diodes includes creating VACFETs without any gate electrodes.

FIG. 7A is a schematic diagram showing another embodiment of a VACFET device 100A that includes magnetic flux concentrating structures 64. The magnetic flux concentrating structures 64 are typically formed from soft-magnetic films such as permalloy, conetic, Fe—Co alloys or films of other well-known soft magnetic materials.

The VACFET device 100A includes a substrate 40, a VACFET formed on the substrate, and at least one magnetic flux concentrating structure for concentrating magnetic flux 59 in the cathode-anode gap 72 of the VACFET.

In the illustrated example, an electron beam path 19 along the cathode-anode gap 72 within the VACFET device 100A is shown. Electrons travel along the electron beam path 19, from the proximal face 9 of the cathode 24 towards the proximal face 11 of the anode 28. The magnetic flux concentrating structures 64 align an external magnetic field produced in FIG. 7B to be along lines of magnetic flux 59 shown in FIG. 7A. Here, the lines of magnetic flux 59 are in the same direction as the flow of electrons in the electron beam path 19.

FIG. 7B shows a VACFET system 200.

The VACFET system 200 includes a magnetic field source that generates a magnetic field, and an integrated circuit chip 60 with VACFET devices 100A of FIG. 7A in the magnetic field.

In the illustrated example, VACFET devices 100A-1 through 100A-N are included/fabricated within the chip 60. Electrical interconnections 63 for each of the VACFET devices 100A are also located on a top surface of the chip 60.

By way of background, VACFET devices 100/100A can have unwanted current induced at its gates 26 by electrons in the electron beam path 19 between the cathode 24 and the anode 28. Any stray electrons from the cathode 24 to the gates 26 reduce the useful output current of the VACFET device 100 and induce excess noise in the output current or voltage of the VACFET device 100. This induced current at the gates 26 typically occurs when stray electrons in the electron beam path 19 come in contact with the one or more gates 26.

To minimize the noise, in one example, the chip 60 including the VACFET devices 100A-1 . . . 100A-N is placed in a magnetic field. Here, the magnetic field source is one or more permanent magnets 62. In one example, as shown in the figure, the permanent magnets 62 are oriented such that the generated magnetic field is substantially parallel to the electron beam path 19 within the VACFET of each VACFET device 100A. In this way, the magnetic field can “steer” electrons of the electron beam path 19 away from the gates 26, thus reducing current induced at the gates 26.

FIG. 8A-8D show simulated trajectories of electron beam paths within different VACFET devices 100. Dimensions of the electron beam path in each FIG. 8A-8D are shown in micrometers.

FIG. 8A shows the trajectory of electrons for a single gate VACFET device 100 not placed in a magnetic field. At least one ray trace of the electrons is shown coming into contact with the single bottom gate 26b. This contact induces unwanted current at the gate 26b, and also reduces efficiency of the VACFET device 100.

FIG. 8B shows the trajectory of electrons for the single gate VACFET device 100 in FIG. 8A when the VACFET device 100 is placed in an external magnetic field. In the illustrated example, the VACFET device 100 is placed in a 1T (Tesla) magnetic field that is substantially perpendicular to the plane of the page. As a result, the electrons in the electron beam path 19 are “steered” upward relative to the substrate 40 and away from the bottom gate 26b.

FIG. 8C shows the trajectory of electrons for a two gate VACFET device 100, such as that in FIG. 2, when the VACFET device 100 is not placed in a magnetic field. Ray traces of the electrons are shown coming into contact with both the top gate 26t and the bottom gate 26b. This contact induces unwanted current and noise at the gates 26. Here, the top gate 26t and the bottom gate 26b are offset symmetrically about the electron beam path 19 between the cathode 24 and the anode 28.

FIG. 8D shows the trajectory of electrons for the two gate VACFET device in FIG. 8C when the VACFET device 100 is placed in an external magnetic field.

In the illustrated example, the VACFET device 100 is placed in a 2T magnetic field that is substantially parallel to the electron beam path 19. As a result, electrons in the electron beam path 19 are “pinched” relative to the gates 26 and spiral around magnetic field lines of the magnetic field as the electrons travel along the electron beam path 19. This significantly reduces the probability that electrons will come in contact with the gates 26, which minimizes the induced gate currents. In one example, the VACFET devices 100 in FIGS. 8B and 8D are VACFET devices 100A in the VACFET system 200 of FIG. 7B.

While this invention has been particularly shown and described with references to preferred embodiments thereof, it will be understood by those skilled in the art that various changes in form and details may be made therein without departing from the scope of the invention encompassed by the appended claims.

What is claimed is:

1. A monolithically fabricated vacuum field effect transistor (VACFET) device, comprising:
a substrate;
a VACFET formed laterally on the substrate; and
a containment shell that seals around a periphery of the VACFET and against the substrate.

2. The device of claim 1, wherein the VACFET includes:
an anode and a cathode formed on the substrate; and
a bottom gate located between the anode and the cathode and the substrate.

3. The device of claim 2, wherein the cathode overlaps the bottom gate.

4. The device of claim 2, wherein the VACFET includes:
a top gate located above the anode and the cathode with respect to the substrate.

5. The device of claim 3, wherein the top gate is housed within the containment shell.

6. The device of claim 3, wherein the cathode overlaps the top gate.

7. The device of claim 2, wherein the anode and the cathode are cantilevered above the substrate and over the bottom gate.

8. The device of claim 1, wherein the device includes a metal plug for closing an opening in the shell and creating a vacuum seal.

9. The device of claim 8, wherein the metal plug functions as a metal contact that provides an electrical connection to the VACFET.

10. A method for monolithic fabrication of a VACFET device, the method comprising:
forming a VACFET laterally on a substrate; and
fabricating a containment shell that seals around a periphery of the VACFET and against the substrate.

11. The method of claim 10, wherein the containment shell is fabricated by:
depositing a shell layer and then patterning the shell layer to form the containment shell; and
removing a sacrificial material and then sealing the containment shell with a metal plug.

12. The method of claim 10, wherein forming the VACFET laterally on the substrate comprises:
fabricating a bottom gate; and then
fabricating an anode and cathode cantilevered over the bottom gate.

13. The method of claim 12, further comprising fabricating the cathode to overlap the bottom gate.

14. The method of claim 12, wherein forming the VACFET laterally on the substrate further comprises fabricating a top gate over the cathode and the anode, with respect to the substrate.

15. The method of claim 14, wherein fabricating the top gate over the cathode and the anode, with respect to the substrate comprises:
fabricating an upper oxide sacrificial layer over the cathode and the anode, with respect to the substrate;
fabricating the top gate on the upper oxide sacrificial layer; and
removing the upper oxide sacrificial layer.

16. The method of claim 14, further comprising fabricating the cathode to overlap the top gate.

17. A monolithically fabricated VACFET, the VACFET comprising:
a substrate;
a bottom gate formed on the substrate;
a cathode and an anode located above the bottom gate; and
a top gate, wherein the top gate and the bottom gate are located at different heights relative to the substrate.

18. The VACFET of claim 17, wherein the top gate and the bottom gate are offset symmetrically about an electron beam path between the cathode and the anode.

19. The VACFET of claim 17, wherein the anode and the cathode are cantilevered above the substrate.

20. A method for monolithic fabrication of a VACFET, the method comprising:
fabricating a bottom gate upon a substrate;
fabricating a cathode and an anode over the bottom gate, with respect to the substrate; and
fabricating a top gate over the cathode and the anode, with respect to the substrate.

21. The method of claim 20, further comprising fabricating a lower oxide sacrificial layer over the bottom gate prior to fabricating the cathode and the anode.

22. The method of claim 20, further comprising the anode and the cathode being cantilevered above the substrate.

23. The method of claim 20, further comprising fabricating an upper oxide sacrificial layer over the cathode and the anode prior to fabricating the top gate.

24. The method of claim 20, further comprising fabricating the cathode to overlap the top gate and the bottom gate.

25. A monolithically fabricated vacuum field effect transistor (VACFET) device, comprising:
a substrate;
a VACFET formed on the substrate; and
at least one magnetic flux concentrating structure for concentrating magnetic flux in a cathode-anode gap of the VACFET.

26. A VACFET system, comprising:
a magnetic field source that generates a magnetic field; and
an integrated circuit chip with VACFET devices in the magnetic field.

27. A method for assembling an integrated circuit VACFET with magnetic guidance, the method comprising:
generating a magnetic field from a magnetic field source; and
placing an integrated circuit chip with VACFET devices in the magnetic field.
